(19) United States
(12) Patent Application Publication
(10) Pub. No.: US 2026/0036017 A1
(43) Pub. Date: Feb. 5, 2026

(54) SUBSEA VALVE ACTUATION SYSTEM

(71) Applicant: FMC Kongsberg Subsea AS, Kongsberg (NO)

(72) Inventors: Kyle Ellis, Kongsberg (NO); Nathan Wittry, Kongsberg (NO)

(21) Appl. No.: 18/998,476

(22) PCT Filed: Jul. 25, 2023
(86) PCT No.: PCT/EP2023/070521

§ 371 Date: Jan. 25, 2025

(30) Foreign Application Priority Data
Jul. 26, 2022 (NO) 20220825

(51) Int. Cl. E21B 34/04; E21B 33/035; E21B 34/06

(52) U.S. Cl. CPC E21B 34/04; E21B 33/0355; E21B 34/066

(57) ABSTRACT

A subsea valve actuation system is disclosed and comprises a contact portion for connecting an actuator to a receptacle, the receptacle for connecting an actuator to a subsea valve. The receptacle comprises a receptacle housing having proximal and distal ends and an internal chamber, wherein the proximal end is connectable to a body of the valve; and each of the contact portion and the receptacle having a longitudinal axis; the contact portion having a first axially facing mating end face; and the receptacle housing having a second axially facing mating end face. One of the first or second mating end faces has protrusions; and the other of the first or second mating end faces defines corresponding recesses for receiving the protrusions.

### TECHNICAL FIELD

The present disclosure relates to a subsea valve actuation system. More particularly, the present disclosure relates to a subsea valve actuation system connectable to a subsea structure with a valve used in the oil and gas industry.

### BACKGROUND

A subsea valve actuation system is used for operating a valve on a subsea X-mas tree. An electric retrievable actuator with rotary output is used to connect to the subsea actuation system to operate the valve. The actuator has a front part that connects to a non-retrievable rotation-to-linear mechanism (RLM) that is fixed to the valve. The RLM is located within a receptacle known as a torque bucket. The torque bucket provides a torque interface of the actuator towards the RLM. A standard anti-rotation connection is formed between the actuator and the RLM to absorb reaction torque. The anti-rotation connection includes through slots in the cylindrical wall of the bucket which cooperate with complementary fins on an outer cylindrical surface of the front part of the actuator. However, these slots and fins interfere with circumferential grooves in the inner cylindrical surface of the bucket for locking the bucket to the actuator. Furthermore, the slots compromise the structural integrity of the bucket.

It is therefore desired to alleviate or mitigate the above disadvantages. It is desirable that any solution is simple, not expensive to produce, and is reliable. It is further a technical problem to avoid cumbersome arrangements that are expensive to manufacture or assemble.

### SUMMARY

Embodiments of the present disclosure provide a subsea valve actuation system, an actuator assembly for a subsea valve, a subsea valve and a subsea valve assembly. This can also be achieved by the features as defined by the independent claims. Further enhancements are characterized by the dependent claims.

In embodiments according to the present disclosure, a subsea valve actuation system comprises; a contact portion for connecting an actuator to a receptacle, a receptacle for connecting an actuator to a subsea valve, the receptacle comprising: a receptacle housing having proximal and distal ends and an internal chamber, wherein the proximal end is connectable to a body of the valve; and each of the contact portion and the receptacle having a longitudinal axis; the contact portion having a first axially facing mating end face; and the receptacle housing having a second axially facing mating end face; wherein one of the first or second mating end faces has protrusions; and the other of the first or second mating end faces defines corresponding recesses for receiving the protrusions; and wherein the respective protrusions and recesses in the first and second mating end faces are configured to provide an anti-rotation interface to absorb the reaction torque during valve actuation.

In embodiments, the protrusions extend radially on said mating end face and axially away from said mating end face; and the recesses extend radially on said mating end face and axially away from said mating end face.

In embodiments, the second mating end face has said protrusions extending radially on the second mating end face and axially away from the second mating end face; and the first mating end face defines said correspondingly shaped recesses for receiving the protrusions, the recesses extending radially on said first mating end face and axially away from said mating end face into the material of the contact portion.

Optionally, each of the first or second mating end faces has said protrusions; and defines said corresponding recesses for receiving the protrusions.

In embodiments, one or more of the recesses have a pair of open radial ends.

In embodiments, one or more of the protrusions is confined within the boundaries of the respective mating end face if viewed in the axial direction.

In embodiments, the proximal end of the receptacle housing is connectable to a body of the valve such that a drive element of the valve is at least partly located in the internal chamber; and the distal end is adapted to receive at least part of a drive mechanism of the actuator such that the drive mechanism and the drive element engage within the internal chamber.

In embodiments, the receptacle housing has an inner circumferential surface defining circumferential grooves and said part of the drive mechanism of the actuator has corresponding circumferential ribs for engaging the circumferential grooves, so as to interlock the receptacle housing and the drive mechanism, wherein the circumferential grooves and the circumferential ribs are spaced apart from the protrusions and the corresponding recesses in said first and second mating end faces when the subsea valve actuation system is assembled.

In embodiments, the subsea valve actuation system further comprises a subsea valve wherein the receptacle is provided on the subsea valve.

In embodiments, the subsea valve actuation system further comprises an actuator for the subsea valve, wherein the contact portion is provided on the actuator.

In embodiments according to the present disclosure, the actuator comprises: an actuator housing having proximal and distal ends; an electric motor located within the actuator housing; a drive mechanism adapted to be driven by the electric motor and engageable with the subsea valve; and wherein the contact portion is provided at the proximal end of the actuator housing.

In embodiments, the contact portion is provided at the proximal end of the actuator housing.

In embodiments, the proximal end of the receptacle housing is connectable to a body of the valve such that a drive element of the valve is at least partly located in the internal chamber; and the distal end is adapted to receive at least part of a drive mechanism of the actuator such that the drive mechanism and drive element engage within the internal chamber.

In embodiments, there is provided a subsea valve comprising an actuator assembly as described above.

In embodiments, there is provided a subsea valve assembly comprising at least one subsea valve as described above.

The respective protrusions and recesses in the first and second mating end faces provide an anti-rotation interface to absorb the reaction torque during valve actuation.

The provision of the respective protrusions and recesses in the first and second mating end faces permits the anti-rotation interface to be spaced apart from and not interfere with the interlocking circumferential grooves on the inner circumferential surface of the receptacle housing and circumferential ribs on the drive mechanism of the actuator. However, these slots and fins interfere with circumferential grooves in the inner cylindrical surface of the receptacle housing for locking the receptacle housing to the actuator. Furthermore, the structural integrity of the receptacle housing is not compromised and the retained structural strength can be relied upon during interlocking of the receptacle housing and the actuator and during general operation of the mechanism, in particular, during the transfer of torque from the drive mechanism of the actuator towards the drive element within the receptacle housing.

It will be appreciated that the terms “axial”, “radial” and their derivatives are used in relation to the longitudinal axes of the contact portion and the receptacle with “axial” meaning “generally along or in the same direction as the longitudinal axis” and “radial” meaning “generally transverse to or in the direction across the longitudinal axis”. The terms “distal and proximal” are used with reference to the subsea valve when the assembly is in use and connected to the valve. For example, the proximal end of the receptacle housing is more proximate the valve than the distal end of the receptacle housing in use when the proximal end is connected to the the subsea valve.

At least one of the above embodiments provides one or more solutions to the problems and disadvantages with the background art. Other technical advantages of the present disclosure will be readily apparent to one skilled in the art from the following description and claims. Various embodiments of the present application obtain only a subset of the advantages set forth. No one advantage is critical to the embodiments. Any claimed embodiment may be technically combined with any other claimed embodiment or embodiments.

### BRIEF DESCRIPTION OF THE DRAWINGS

The accompanying drawings illustrate presently example embodiments of the disclosure and serve to explain, by way of example, the principles of the embodiments.

FIG. 1 is a schematic illustration of an actuation system according to an example embodiment of the disclosure;

FIG. 2 is a schematic illustration of an actuator part of the actuation system of FIG. 1;

FIG. 3 is a schematic illustration of a receptacle of the actuation system of FIG. 1;

FIG. 4 is a schematic illustration of a longitudinal cross-section of an assembled actuation system according to another example embodiment of the disclosure; and

FIG. 5 is a schematic illustration of a transverse cross-section of the actuation system of FIG. 4.

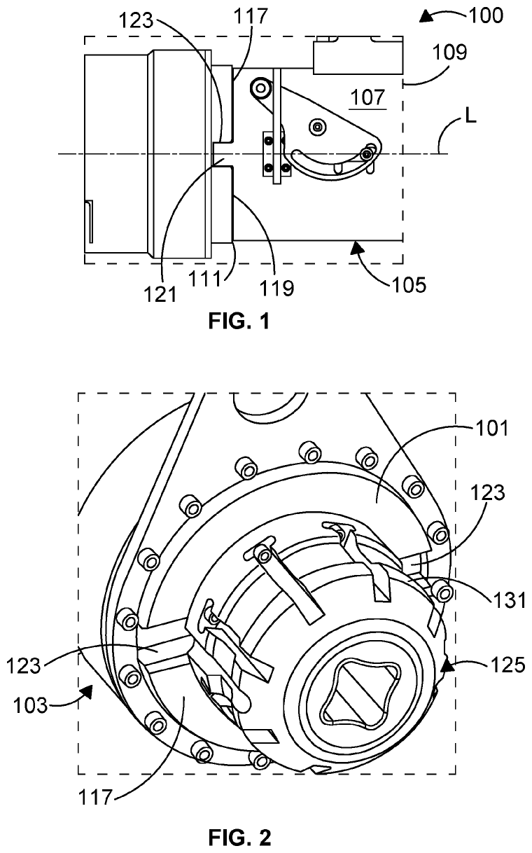

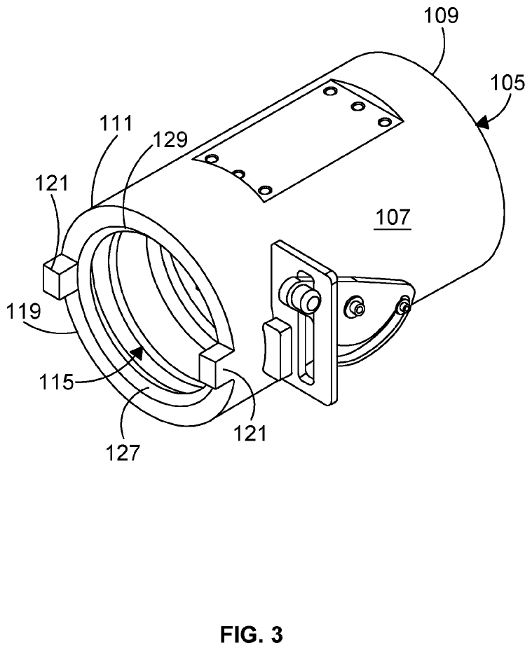

### DETAILED DESCRIPTION

In the drawings, a subsea valve actuation system in accordance with the present disclosure is indicated generally using reference numerals 100, 200. Like features have been indicated using the like reference numerals for brevity.

The subsea valve actuation system 100, 200 comprises a contact portion 101, 201 for connecting an actuator (only front portions 103, 203 of the actuator are shown in the drawings) to a receptacle 105, 205 for connecting the actuator to a subsea valve (not shown).

The receptacle 105, 205 comprises a receptacle housing 107, 207 having a proximal end 109, 209 and a distal end 111, 211 and an internal chamber 115, 215, wherein the proximal end 109, 209 is connectable to a body of the valve. Each of the contact portion 101, 201 and the receptacle 105, 205 have a longitudinal axis L. The contact portion 101, 201 has a first axially facing mating end face 117, 217 and the receptacle housing 107, 207 has a second axially facing mating end face 119, 219.

In the presently described embodiments, the second mating end face 119, 219 has protrusions 121, 221 and the first mating end face 117, 217 defines corresponding recesses 123, 223 for receiving the protrusions 121, 221. In other embodiments not shown in the drawings, the first mating end face 117, 217 can have protrusions 121, 221 and the second mating end face 119, 219 can define corresponding recesses 123, 223 for receiving the protrusions 121, 221.

The protrusions 121, 221 extend radially on the second mating end face 119, 219 and axially away from the second mating end face 119, 219; and the recesses 123, 223 extend radially on the first mating end face 117, 217 and axially away from the first mating end face 117, 217 into the material of the contact portion.

In other embodiments not shown in the drawings, each of the first mating end faces 117, 217 and second mating end faces 119, 219 has the protrusions 121, 221 and defines the corresponding recesses 123, 223 for receiving the protrusions 121, 221.

The protrusions 121, 221 and recesses 123, 223 provide an anti-rotation interface to absorb the reaction torque during valve actuation.

The recesses 123 have a pair of open radial ends (not indicated by a reference numeral).

The protrusions 121, 221 are confined within the boundaries of the second mating end face 119, 219 if viewed in the axial direction.

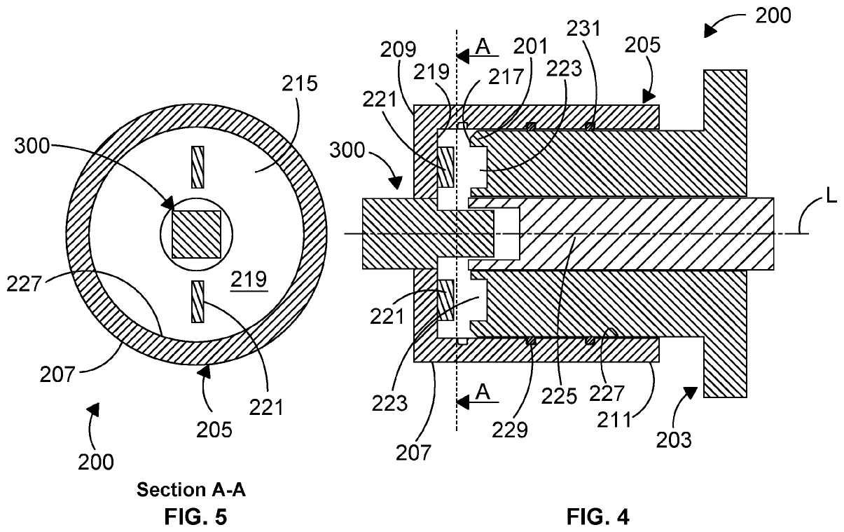

The proximal end 109, 209 of the receptacle housing 107, 207 is connectable to a body of the valve (not shown) such that a drive element (indicated 300 in FIGS. 4 and 5) of the valve is at least partly located in the internal chamber 115, 215; and the distal end 111, 211 is adapted to receive at least part of a drive mechanism 125, 225 of the actuator such that the drive mechanism 125, 225 and the drive element 300 engage within the internal chamber 115, 215.

The receptacle housing 107, 207 has an inner circumferential surface 127, 227 defining circumferential grooves 129, 229 and the part of the drive mechanism 125, 225 of the actuator received within the internal chamber 115, 215 has corresponding circumferential ribs 131, 231 for engaging the circumferential grooves 129, 229, so as to interlock the receptacle housing 107, 207 and the drive mechanism 125, 225 to prevent axial displacement. The circumferential grooves 129, 229 and the circumferential ribs 131, 231 are spaced apart from the protrusions 121, 221 and the corresponding recesses 123, 223 when the subsea valve actuation system 100, 200 is assembled.

Although not shown in the drawings, the actuator typically comprises an actuator housing having proximal and distal ends and an electric motor located within the actuator housing. The drive mechanism 125, 225 is adapted to be driven by the electric motor and engageable with the subsea valve via the drive element 300. The contact portion 101, 201 is provided at the proximal end of the actuator housing.

This written description uses examples to disclose various embodiments of the present disclosure and also to enable any person skilled in the art to practice the various embodiments, including making and using the adapters and performing the methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1-15. (canceled)

16. A subsea valve actuation system, comprising:
an actuator housing for housing an actuator, the actuator housing including a contact portion; and
a receptacle for receiving the actuator, the receptacle including:
a receptacle housing having a proximal end, a distal end, and an internal chamber, the proximal end configured to connect to a body of a valve,
wherein the contact portion and the receptacle housing each have a longitudinal axis, wherein the contact portion has a first mating end face that faces axially and the receptacle housing has a second mating end face that faces axially,
wherein one of the first mating end face or the second mating end face has protrusions, and the other of the first mating end face or the second mating end face defines corresponding recesses for receiving the protrusions, the respective protrusions and recesses configured to provide an anti-rotation interface between the first mating end face and the second mating end face that absorb a reaction torque during valve actuation.

17. The subsea valve actuation system of claim 16, wherein the protrusions extend radially and axially away on either the first mating end face or the second mating end face, and the recesses extend radially and axially away on the other of the first mating end face or the second mating end face.

18. The subsea valve actuation system of claim 16, wherein the second mating end face has the protrusions extending radially and axially away from the second mating end face, and the first mating end face defines the correspondingly shaped recesses for receiving the protrusions, the recesses extending radially and axially away from the first mating end face into the material of the contact portion.

19. The subsea valve actuation system of claim 16, wherein each of the first mating end face and the second mating end face has the protrusions and the recesses for receiving the respective protrusions.

20. The subsea valve actuation system of claim 16, wherein one or more of the recesses have a pair of open radial ends.

21. The subsea valve actuation system of claim 16, wherein one or more of the protrusions in confined within a boundary of the respective mating end face when viewed along the longitudinal axis.

22. The subsea valve actuation system of claim 16, wherein the proximal end of the receptacle housing is configured to connect to the body of the valve such that a drive element of the valve is at least partly located in the internal chamber, and the distal end is configured to receive at least part of a drive mechanism of the actuator such that the drive mechanism and the drive element engage within the internal chamber.

23. The subsea valve actuation system of claim 22, wherein the receptacle housing has an inner circumferential surface defining a set of circumferential grooves, wherein a portion of the drive mechanism of the actuator has a corresponding set of circumferential ribs for engaging the set of circumferential grooves so as to interlock the receptacle housing and the drive mechanism, wherein the set of circumferential grooves and the set of circumferential ribs are spaced apart from the protrusions and the corresponding recesses when the subsea valve actuation system is assembled.

24. The subsea valve actuation system of claim 16, further comprising a subsea valve wherein the receptacle is provided on the subsea valve.

25. The subsea valve actuation system of claim 24, further comprising an actuator for the subsea valve, wherein the contact portion is provided on the actuator.

26. The subsea valve actuation system of claim 25, wherein the actuator comprises:
the actuator housing having a proximal end and a distal end;
an electric motor located within the actuator housing;
a drive mechanism configured to be driven by the electric motor and engageable with the subsea valve; and
wherein the contact portion is provided at the proximal end of the actuator housing.

27. The subsea valve actuation system of claim 26, wherein the contact portion is provided at the proximal end of the actuator housing.

28. The subsea valve actuation system of claim 27, wherein the proximal end of the receptacle housing is configured to connect to a body of the valve such that a drive element of the valve is at least partly located in the internal chamber, and the distal end is adapted to receive at least part of a drive mechanism of the actuator such that the drive mechanism and the drive element engage within the internal chamber.
